(19) United States
(12) Patent Application Publication
(10) Pub. No.: US 2026/0278009 A1
(43) Pub. Date: Sep. 17, 2026

(54) OPERATOR-BASED FILTERING APPARATUS AND METHOD FOR SELECTING RELEVANT DIGITAL EVIDENCE

(71) Applicant: ELECTRONICS AND TELECOMMUNICATIONS RESEARCH INSTITUTE, Daejeon (KR)

(72) Inventors: Junsu KIM, Daejeon (KR); Hyunuk HWANG, Daejeon (KR); Seungyong LEE, Daejeon (KR); Junghoon OH, Daejeon (KR); Joongsoo HAN, Daejeon (KR); Ju Hyung SONG, Daejeon (KR)

(21) Appl. No.: 19/564,343

(22) Filed: Mar. 12, 2026

(30) Foreign Application Priority Data
Mar. 13, 2025 (KR) 10-2025-0032776

(51) Int. Cl. G06F 16/9035; G06F 16/904

(52) U.S. Cl. CPC G06F 16/9035; G06F 16/904

(57) ABSTRACT

Disclosed herein is an apparatus and method for operator-based filtering for selecting relevant digital evidence. The apparatus includes memory in which at least one program is recorded and a processor for executing the program. The program may perform creating at least one filter in response to a request from a user, adding the created at least one filter to a filter execution plan, filtering pieces of digital evidence given as input using the at least one filter added to the filter execution plan, and visualizing the result of the filtering.

### CROSS REFERENCE TO RELATED APPLICATION

This application claims the benefit of Korean Patent Application No. 10-2025-0032776, filed Mar. 13, 2025, which is hereby incorporated by reference in its entirety into this application.

### BACKGROUND OF THE INVENTION

### 1. Technical Field

The disclosed embodiment relates to technology for selecting relevant digital evidence.

### 2. Description of Related Art

Since the revision of Article 106(3) of the Criminal Procedure Act in 2016 and the establishment of new regulations on mutual cooperation between prosecutors and judicial police officers and general investigation standards in 2021 in South Korea, the seizure and search of digital evidence have been based on the fundamental principle of selecting and extracting only digital evidence relevant to the facts of the crime from the digital storage medium of the individual whose device is subject to seizure.

At the site of seizure or search, only a limited number of personnel are available for a limited time. Therefore, a technology for selecting relevant digital evidence that can efficiently identify and extract only information relevant to the facts of the crime from the storage medium of the individual whose device is subject to seizure is a critical factor for conducting efficient investigation, inspection, and audit.

Although representative tools used in the field of digital forensics, such as Magnet’s AXIOM, OpenText’s EnCase, AccessData’s FTK, X-Ways Software Technology AG’s X-Ways Forensics, and other tools, provide technologies for selecting relevant digital evidence, they offer only basic functions that simply check specific attribute values to identify digital evidence, or they require complex configurations to enable the selection of relevant digital evidence based on composite conditions. Therefore, they have limitations in effectively acquiring the digital evidence required by users. Furthermore, the low-level visualization of the results of selecting relevant digital evidence forces users to make additional efforts to interpret the acquired evidence, thereby impeding efficient investigation, inspection, and audit.

### SUMMARY OF THE INVENTION

An object of the disclosed embodiment is to provide technology for selecting relevant digital evidence, enabling efficient acquisition of the evidence required by a user from among large volumes of digital evidence.

Another object of the disclosed embodiment is to provide a method for intuitive visualization of the results of selecting relevant digital evidence, thereby supporting efficient investigation, inspection, and audit of digital evidence.

An apparatus for operator-based filtering for selecting relevant digital evidence according to an embodiment includes memory in which at least one program is recorded and a processor for executing the program, and the program may perform creating at least one filter in response to a request from a user and adding the created at least one filter to a filter execution plan, filtering digital evidence provided as input using the at least one filter added to the filter execution plan, and visualizing the result of the filtering.

Here, the filter may be configured with an operator, a state, and at least one condition.

Here, the operator may include at least one of a logical operator, a set operator, a relational operator, or a user-defined operator, or a combination thereof.

Here, the condition may include at least one of a first condition type configured with (attribute i, an operator p in the condition, and a value j) to check whether a relationship between a value acquired from attribute i of the digital evidence and the value j satisfies the operator p, a second condition type configured with (attribute i, an operator q in the condition, and an attribute j) to check whether a relationship between a value acquired from attribute i of the digital evidence and a value acquired from attribute j satisfies the operator or a third condition type configured with (set i, an operator r in the condition, and set j) to check whether the digital evidence set i and the digital evidence set j satisfy the operator r as operands, or a combination thereof.

Here, when adding the created at least one filter, the program may perform creating a composite filter by combining the at least one created filter with at least one additional filter through an operator.

Here, the order in which the at least one filter added to the filter execution plan is applied may be changed using an execution plan optimization technique.

Here, when filtering digital evidence, the program may perform setting an item list comprising all digital evidence as input to the filter, sequentially extracting a filter in an enabled state from the filter execution plan, and performing operator-based filtering on the item list using the sequentially extracted filter.

Here, when performing the operator-based filtering, the program may perform acquiring a condition from the filter, extracting at least one item that satisfy the acquired condition from the item list, and initializing the item list or adding the extracted at least one item based on a type of an operator set in the filter.

Here, when the operator is AND, the program initializes the item list and adds the extracted at least one item to the item list, whereas when the operator is OR, the program adds the extracted at least one item to the item list without initialization of the item list.

Here, the result of the filtering may include an area for filter visualization and an area for result item visualization, and the filter may be visualized through a visualization button.

Here, the program may further perform filter update for modifying conditions of the filter, and when performing the filter update, the program may perform receiving a selection of a visualization button corresponding to a target filter, the condition of which is to be modified, from the user and performing at least one of modification of the condition of the selected filter, modification of the state of the selected filter, or removal of the selected filter, or a combination thereof depending on input by the user.

A method for operator-based filtering for selecting relevant digital evidence according to an embodiment may include creating at least one filter in response to a request from a user and adding the created at least one filter to a filter execution plan, filtering digital evidence provided as input using the at least one filter added to the filter execution plan, and visualizing the result of the filtering.

Here, the filter may be configured with an operator, a state, and at least one condition.

Here, the operator may include at least one of a logical operator, a set operator, a relational operator, or a user-defined operator, or a combination thereof.

Here, the condition may include at least one of a first condition type configured with (attribute i, an operator p in the condition, and a value j) to check whether a relationship between a value acquired from attribute i of the digital evidence and the value j satisfies the operator p, a second condition type configured with (attribute i, an operator q in the condition, and an attribute j) to check whether a relationship between a value acquired from attribute i of the digital evidence and a value acquired from attribute j satisfies the operator q or a third condition type configured with (set i, an operator r in the condition, and set j) to check whether the digital evidence set i and the digital evidence set j satisfy the operator r as operands, or a combination thereof.

Here, adding the created at least one filter may include creating a composite filter by combining the created at least one filter with at least one additional filter through an operator.

Here, filtering the digital evidence may include setting an item list comprising all digital evidence as input to the filter, sequentially extracting a filter in an enabled state from the filter execution plan, and performing operator-based filtering on the item list using the sequentially extracted filter.

Here, performing the operator-based filtering may include acquiring a condition from the filter, extracting at least one item that satisfy the acquired condition from the item list, and initializing the item list or adding the extracted at least one item based on a type of an operator set in the filter.

Here, the result of the filtering may include an area for filter visualization and an area for result item visualization, and the filter may be visualized through a visualization button.

Here, the method may further include performing filter update for modifying conditions of the filter, and performing the filter update may include receiving a selection of a visualization button corresponding to a target filter, the condition of which is to be modified, from the user and performing at least one of modification of the condition of the selected filter, modification of the state of the selected filter, or removal of the selected filter, or a combination thereof depending on input by the user.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a schematic configuration diagram of an apparatus for operator-based filtering for selecting relevant digital evidence according to an embodiment;

FIG. 2 is a flowchart for explaining a method for operator-based filtering for selecting relevant digital evidence according to an embodiment;

FIG. 3 is a view for explaining the concept of filters and filtering used in an embodiment;

FIG. 4 is an exemplary view of digital evidence according to an embodiment;

FIG. 5 is another exemplary view of digital evidence according to an embodiment;

FIG. 6 is a flowchart for explaining a filter creation step according to an embodiment;

FIG. 7 is a view illustrating an example of a filter using the logical operator AND;

FIG. 8 is a view illustrating an example of a filter using the logical operator OR;

FIG. 9 is an exemplary view of condition types according to an embodiment;

FIGS. 10 and 11 are exemplary views of composite filters;

FIG. 12 is an exemplary view of an execution plan according to an embodiment;

FIG. 13 is an exemplary view of a dialog box for creating a filter;

FIG. 14 is an exemplary view of addition of a condition entered in text form;

FIG. 15 is an exemplary view of operator and value input section using a time range as a condition;

FIG. 16 is an exemplary view of an operator and value input section using a size range as a condition;

FIG. 17 is an exemplary view of an operator and value input section where a specific value is selected and used as a condition;

FIG. 18 is a flowchart for explaining a filtering step according to an embodiment;

FIG. 19 is a flowchart for explaining operator-based filtering according to an embodiment;

FIG. 20 is an exemplary view of operator-based filtering when the logical operator AND is set for a filter;

FIG. 21 is an exemplary view of operator-based filtering when the logical operator OR is set for a filter;

FIG. 22 is an exemplary view of a filter dialog box where the result is set to be output to a new list;

FIG. 23 is an exemplary view of filtering when the filtering result is output to a new list;

FIG. 24 is an exemplary view of a visualized filtering result according to an embodiment;

FIG. 25 is a flowchart for explaining a filtering visualization step according to an embodiment;

FIG. 26 is an exemplary view of filter visualization according to an embodiment;

FIG. 27 is an exemplary view of a visualization button displaying condition content according to an embodiment;

FIG. 28 is an exemplary view of a visualization button showing the enabled state of a filter;

FIG. 29 is an exemplary view of switching between enabled and disabled states in filter visualization;

FIG. 30 is a flowchart for explaining a filter update step according to an embodiment;

FIG. 31 is an exemplary view of a context menu for a filter visualization button;

FIG. 32 is an exemplary view of filtering result visualization when the filtering result is output to a new list;

FIG. 33 is an exemplary view of filter condition modification according to an embodiment;

FIG. 34 is an exemplary view of deletion of a filter visualization button according to an embodiment;

FIG. 35 is an exemplary view of an integrated context menu of a filter visualization button;

FIG. 36 is a concept diagram for explaining a filtering process using a visualization button; and

FIG. 37 is an exemplary view of a JSON file used to store filter information.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

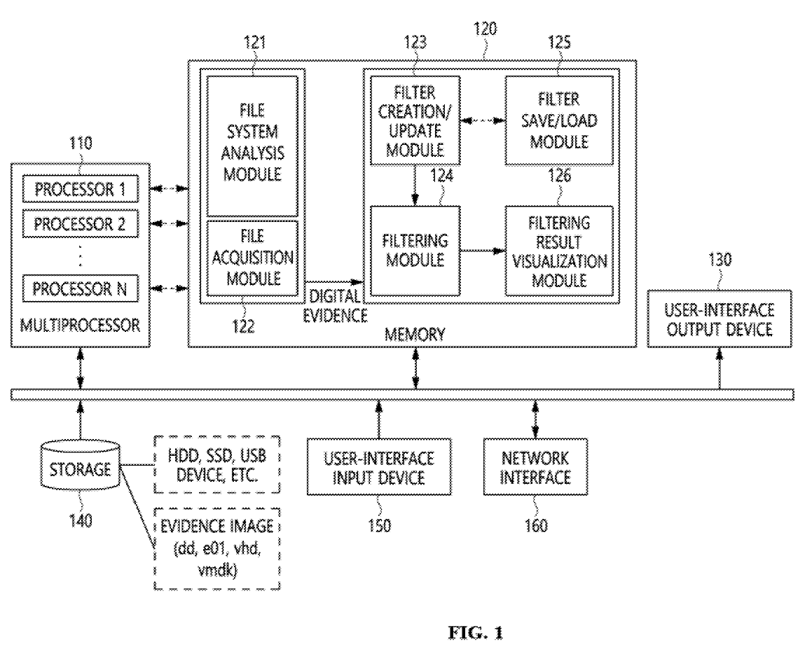

FIG. 1 is a schematic diagram illustrating the configuration of an apparatus for operator-based filtering for selecting relevant digital evidence according to an embodiment.

Referring to FIG. 1, the apparatus for operator-based filtering for selecting relevant digital evidence according to an embodiment is illustrated as including components of the disclosure arranged in a general computer structure, which is configured with a processor (110), memory (120), a storage device (140), user-interface input and output devices (130, 150), a network interface (160), and other components.

The multi-processor (110) may be configured as a single processor, and devices such as the network interface (160), the user-interface input device (150), the user-interface output device (130), and similar devices may be omitted if not required. The storage (140) may be connected either through the network interface (160) or via a physical connection. Furthermore, although not illustrated in FIG. 1, additional devices may be added if necessary.

In an embodiment, the target storage may be a physical storage device such as an HDD, an SSD, a USB drive, and the like, or an evidence image in a file format having extensions such as dd, e01, l01, ad1, vhd, vmdk, dmg, zip, and the like.

In an embodiment, digital evidence serving as input data may be acquired via a file system analysis engine or module of digital forensic tools. Digital evidence may also be acquired via a module that obtains files through the operating system or related APIs of general-purpose programs other than digital forensic tools.

In an embodiment, digital evidence may include various forms used in the field of digital forensics, such as files, metadata, analysis results, and the like. However, in an embodiment, the file form is used as the standard for digital evidence for descriptive convenience.

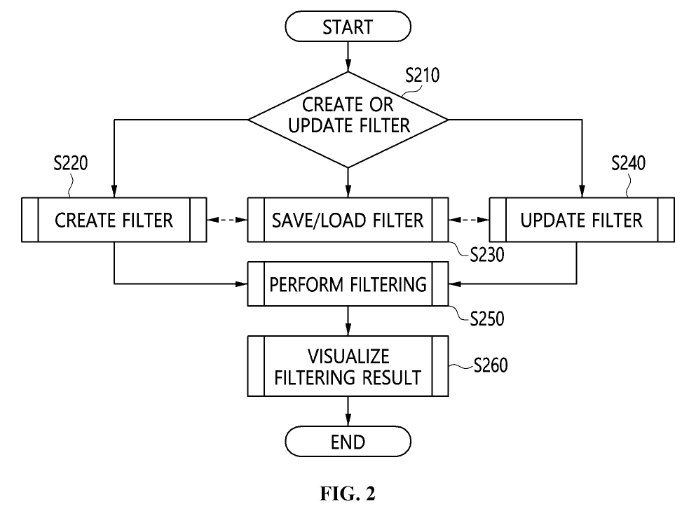

FIG. 2 is a flowchart for explaining a method for operator-based filtering for selecting relevant digital evidence according to an embodiment.

Referring to FIG. 2, the method for operator-based filtering for selecting relevant digital evidence according to an embodiment may include creating a filter to be used at step S220, filtering the input digital evidence using the created filter at step S250, and visualizing the filtering results at step S260.

Here, the method for operator-based filtering for selecting relevant digital evidence according to an embodiment may further include, when there is a filter created at the filter creation step (S220), updating the filter by modifying the conditions of the filter at step S240.

After the filter is updated, the filtering step (S250) and the filtering result visualization step (S260) may be performed in the same manner as being performed at the filter creation step (S220).

The filter created at the filter creation step (S220) or the filter modified at the filter update step (S240) may be stored as a file, and a previously stored filter may be loaded from a file through the filter save/load step (S230) in response to a request from a user.

The term ‘filtering’ used in an embodiment refers to sorting out only the digital evidence desired by a user from among the pieces of digital evidence provided as input, and the conditions, relationships between conditions, or sets of conditions used for this purpose are collectively referred to as filters.

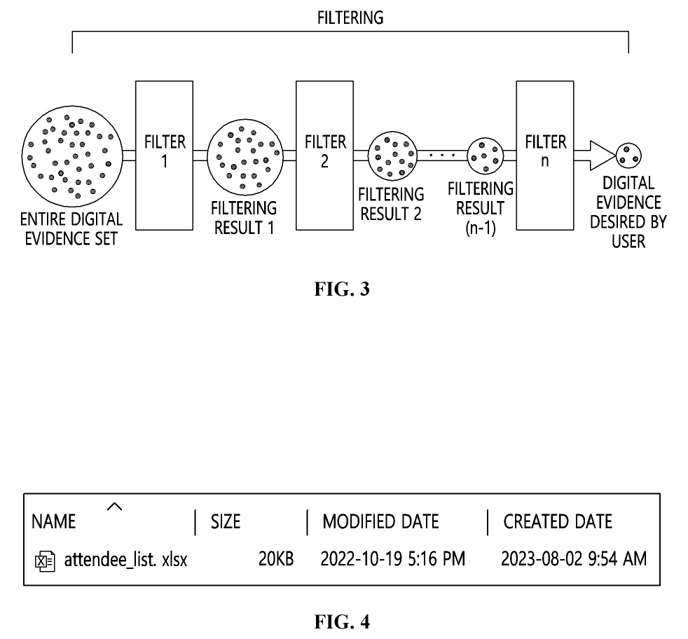

FIG. 3 is a view for explaining the concept of filters and filtering used in an embodiment.

Referring to FIG. 3, digital evidence items are depicted as dots, and when an entire evidence set is given, a user may perform filtering using filters.

When filtering is performed, only digital evidence satisfying the filter is obtained as the filtering result. The user may apply multiple filters sequentially to acquire the desired digital evidence from the entire evidence set.

In general, as filtering proceeds, the number of digital evidence items in the filtering result progressively decreases, and the final result can ultimately include only the digital evidence desired by the user.

In an embodiment, each digital evidence item in the entire evidence set is treated as having a plurality of attributes with corresponding attribute values.

FIG. 4 is an exemplary view of digital evidence according to an embodiment.

For example, digital evidence may be an Excel file as illustrated in FIG. 4, and it can be seen that the corresponding file has attributes such as name, size, modified date, and created date. In that example, the file has attribute values of “attendee list.xlsx” (name), “20 KB” (size), “2022-10-19 5:16 PM” (modified date), and “2023-08-02 9:54 AM” (created date).

In an embodiment, digital evidence, such as a file, is treated as a single item having multiple attributes, and digital evidence items are aggregated to form a digital evidence set. Each item may be stored and managed in an appropriate data structure and utilized in the process of selecting relevant digital evidence.

The digital evidence set may be implemented using a data structure suitable for the purpose, such as an item list configured with digital evidence items, an item set, or an item tree, as needed.

Another example of digital evidence may include information obtained through the analysis of digital artifacts.

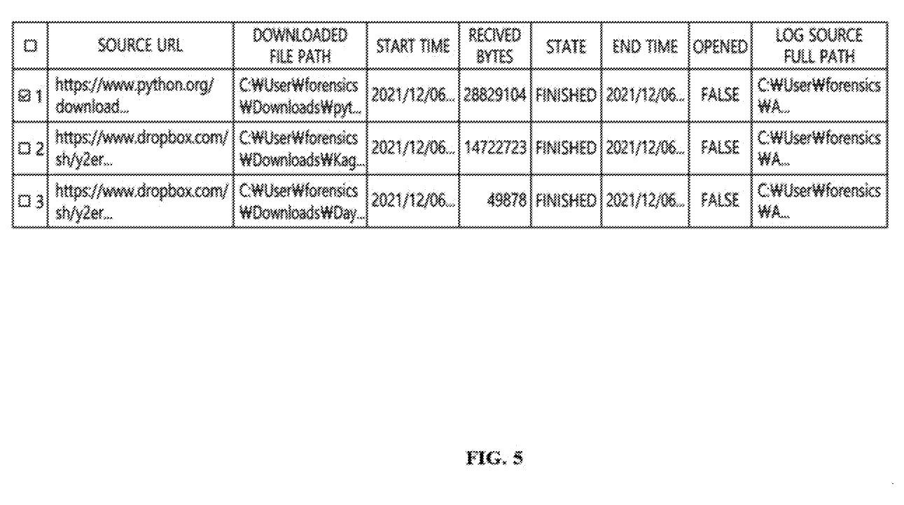

FIG. 5 is another exemplary view of digital evidence according to an embodiment.

Referring to FIG. 5, in the case of download information obtained by analyzing the Google Chrome browser history, each download record may be treated as digital evidence.

FIG. 5 illustrates three download records. When represented as in FIG. 3, each download record may be depicted as a single dot.

Each download record includes attributes such as source URL, downloaded file path, start time, end time, received bytes, total bytes, state, opened, and log source full path, with corresponding attribute values for each attribute.

At the filter creation step (S220) in FIG. 2, a filter is created in response to a user request, and the created filter is added to a filter execution plan.

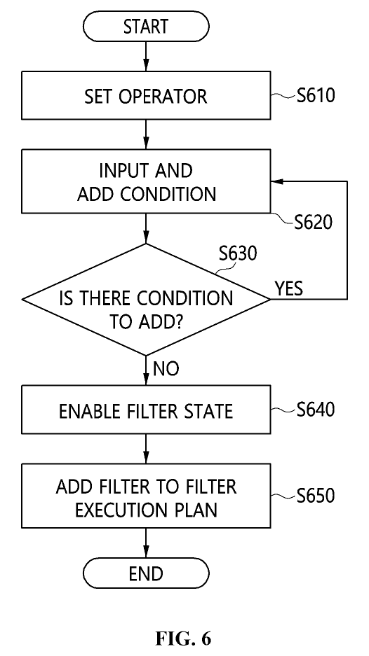

FIG. 6 is a flowchart for explaining a filter creation step according to an embodiment.

Referring to FIG. 6, when the filter creation step (S220) is started, a type of operator to be set is selected at step S610.

Next, a condition is entered and added at step S620. If there are no additional conditions to add at step S630, the filter state is set to enabled at step S640, and the filter is then added to the filter execution plan at step S650.

Otherwise, if additional conditions remain to be added at step S630, the process returns to step S620 to enter and add a condition.

In addition to the foregoing attributes, various other attributes may be used, including, for example, file extension, access time, creation time, entry change time, Trash empty time, deletion status, encryption status, DRM status, MD5 hash, SHA-1 hash, SHA-256 hash, file path, and file signature. For image files, image-specific attributes such as image width and height may be used, and for video files, video-specific attributes such as duration and codec may be used. In addition, keywords appearing in file contents may also be used as attributes, depending on the application.

The filter created through the steps shown in FIG. 6 may be configured with an operator, a state, and at least one conditions.

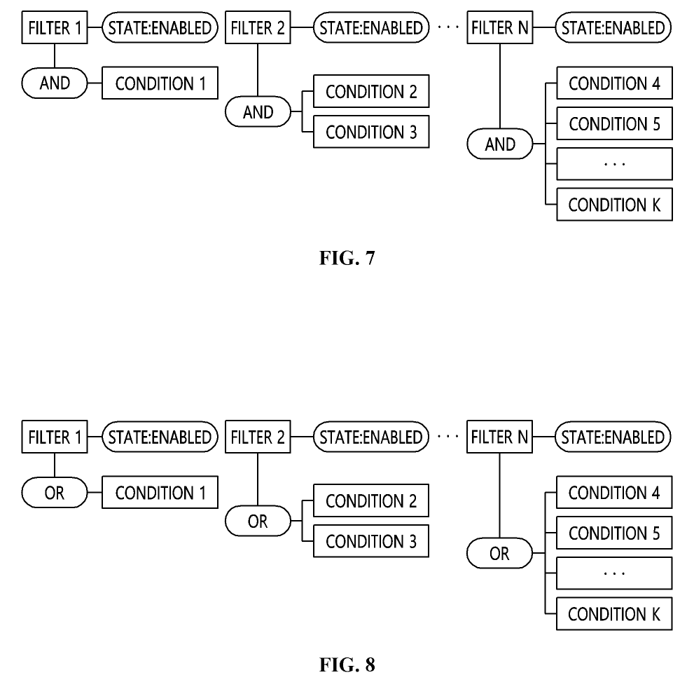

FIG. 7 is a view illustrating an example of a filter using the logical operator AND.

Referring to FIG. 7, the operator may be of various types, including logical operators such as AND, OR, and the like; set operators such as union, intersection, and the like; relational operators such as join, Cartesian product, and the like; and user-defined operators.

FIGS. 7 and 8 illustrate, for descriptive convenience, examples of filters using the logical operators AND and OR.

In FIG. 7, filter 1 is a filter using the logical operator AND and having a single condition, and filter 2 is a filter using the logical operator AND and having two conditions. Filter N is a filter using the logical operator AND and having k conditions (k ≥ 1). The number of conditions constituting a filter is not limited.

FIG. 8 is a view illustrating an example of a filter using the logical operator OR.

In the example illustrated in FIG. 8, the filter may include k conditions, where k is any positive integer; the number of conditions is not particularly limited.

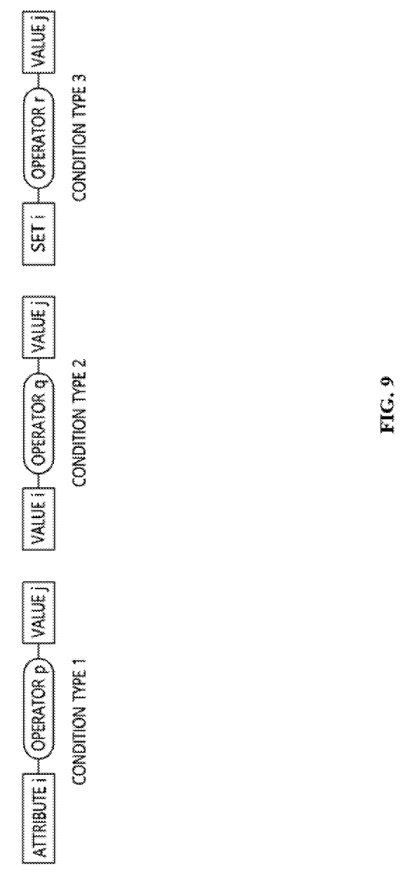

As illustrated in FIG. 9, representative examples of conditions added to a filter through the step S620 (condition entry and addition) may include condition type 1, condition type 2, and condition type 3.

Condition type 1 is a condition configured with (attribute i, an operator p in the condition, and a value j) to check whether a relationship between a value acquired from attribute i of the digital evidence and the value j satisfies the operator p. For example, a condition for searching files whose file size is greater than 1 MB may be expressed as ‘(file size, >, 1 MB)’.

Condition type 2 is a condition configured with (attribute i, an operator q in the condition, and an attribute j) to check whether a relationship between a value acquired from attribute i of the digital evidence and a value acquired from attribute j satisfies the operator q. For example, a condition that searches for files whose creation time is earlier than their modification time may be expressed as ‘(file creation time, <, file modification time)’.

Condition type 3 is a condition configured with (set i, an operator r in the condition, and set j) to check whether the digital evidence set i and the digital evidence set j, as operands, satisfy the operator r. For example, a condition that searches for files belonging to both file set 1 and file set 2 (i.e., their intersection) may be expressed as ‘(file set 1, ∩, file set 2)’.

As an example of the above-described condition types, a binary operator with two operands is described for descriptive convenience; however, depending on the application, unary, ternary, or n-ary operators may also be used. In addition, values, attributes, and sets may serve as operands depending on the application, and, as needed, definitions and results of operations, among others, may also serve as operands.

The filters illustrated in FIGS. 7 and 8, which is created by the above-described filter creation step (S220), may be combined with at least one other filters using an operator to create a composite filter.

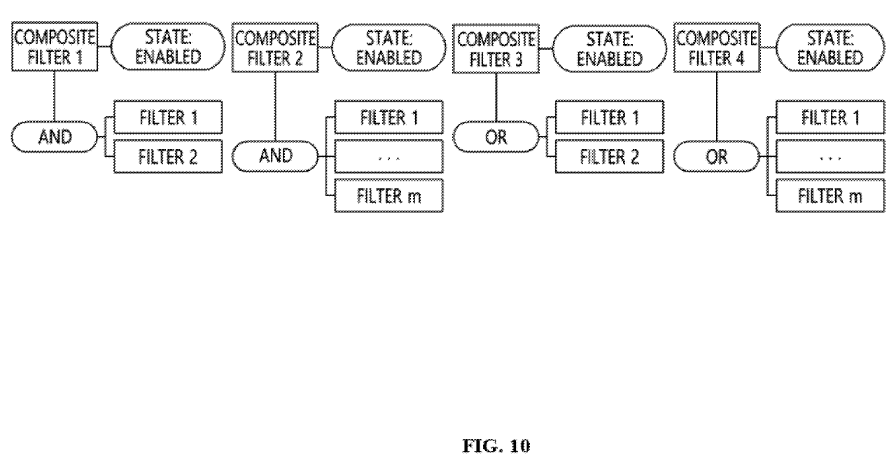

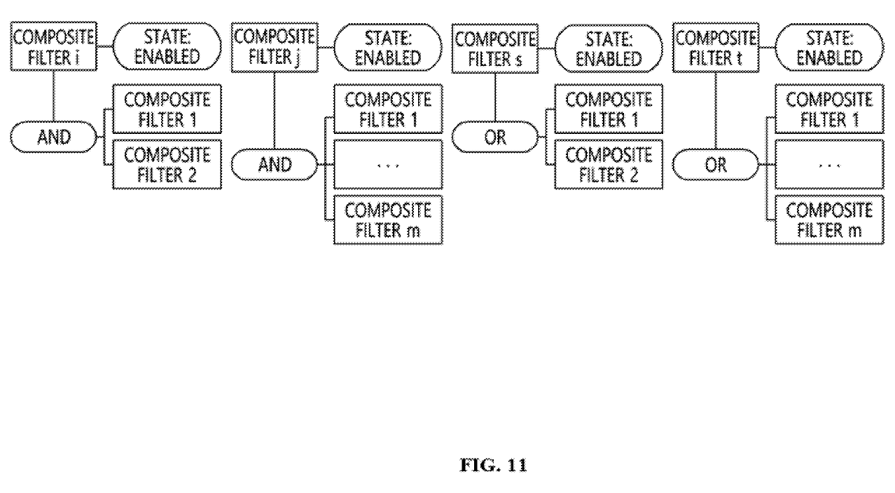

FIGS. 10 and 11 are exemplary views of composite filters.

Referring to FIGS. 10 and 11, a composite filter may be created by combining two or more filters using the logical operators AND and/or OR, and may then be used depending on the application.

In an embodiment, a user may create and use one or more filters to select relevant digital evidence items desired by the user from a large volume of digital evidence. Each filter has a state (enabled or disabled), and only enabled filters participate in the filtering process.

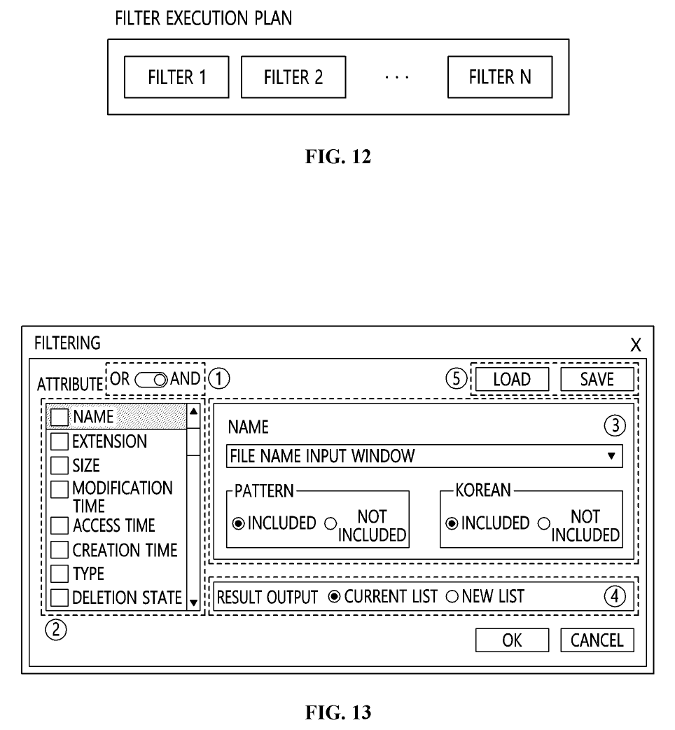

The filter created through the above-described filter creation step (S220) is added to the filter execution plan, as illustrated in FIG. 12. The application order of filters in the filter execution plan may be changed using an execution plan optimization technique.

FIG. 13 is an exemplary view of a dialog box for creating a filter.

Referring to FIG. 13, an example of a filter having a type 1 condition is illustrated. The dialog box can be broadly divided into: ① an operator settings section; ② a target attribute selection section; ③ a condition operator and value input section; ④ a result output list settings section; and ⑤ a save/load management section.

In the operator settings section, the operator to be used when creating the filter (AND or OR) is set. In the target attribute selection section, attribute i of the condition (attribute i, an operator p in the condition, and a value j) is selected.

In the condition operator and value input section, the operator p and the value j of the condition (attribute i, an operator p in the condition, and a value j) are entered. Depending on the selected attribute, appropriate input components are displayed, through which the operator p and the value j may be entered.

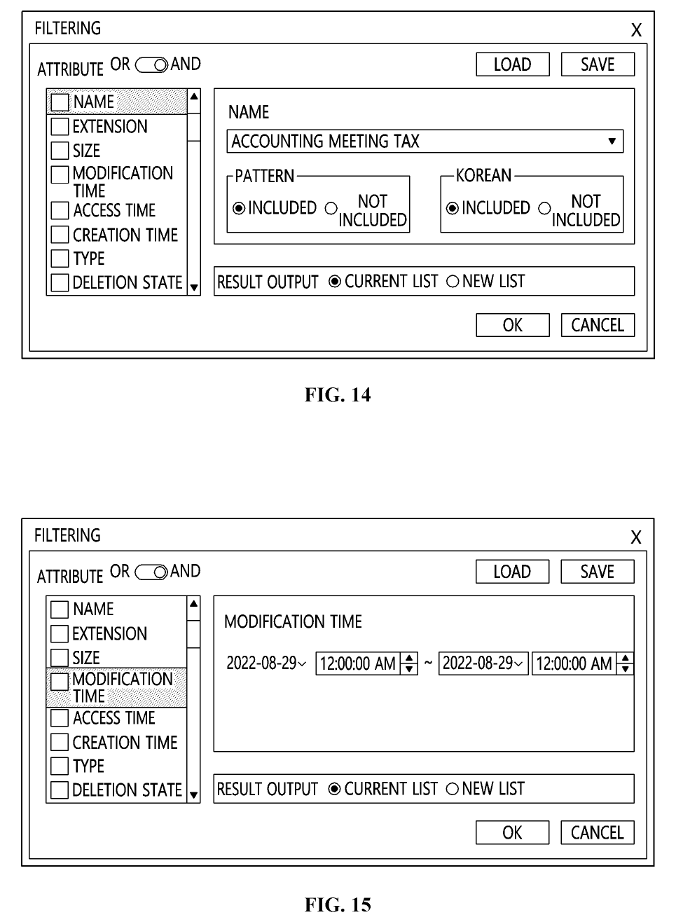

FIG. 14 illustrates an exemplary interface for entering and adding a condition in text form.

Referring to FIG. 14, multiple keywords may be entered simultaneously when entering a condition in text form.

In the example of FIG. 14, a condition is created to search for files whose name attribute contains any of ‘accounting’, ‘meeting’, or ‘tax’; in the form (attribute i, an operator p in the condition, and a value j), this may be expressed as ‘(name, contains any of, accounting meeting tax)’. Alternatively, depending on the application, a condition to search for files whose name attribute contains all of ‘accounting’, ‘meeting’, and ‘tax’ may be created, which may be expressed as ‘(name, contains all of, accounting meeting tax)’.

In addition to the operator and value input section for conditions in text form (see FIG. 14), an operator and value input section for time-range conditions, applicable to attributes such as modification time, access time, and creation time, may also be provided, as illustrated in FIG. 15.

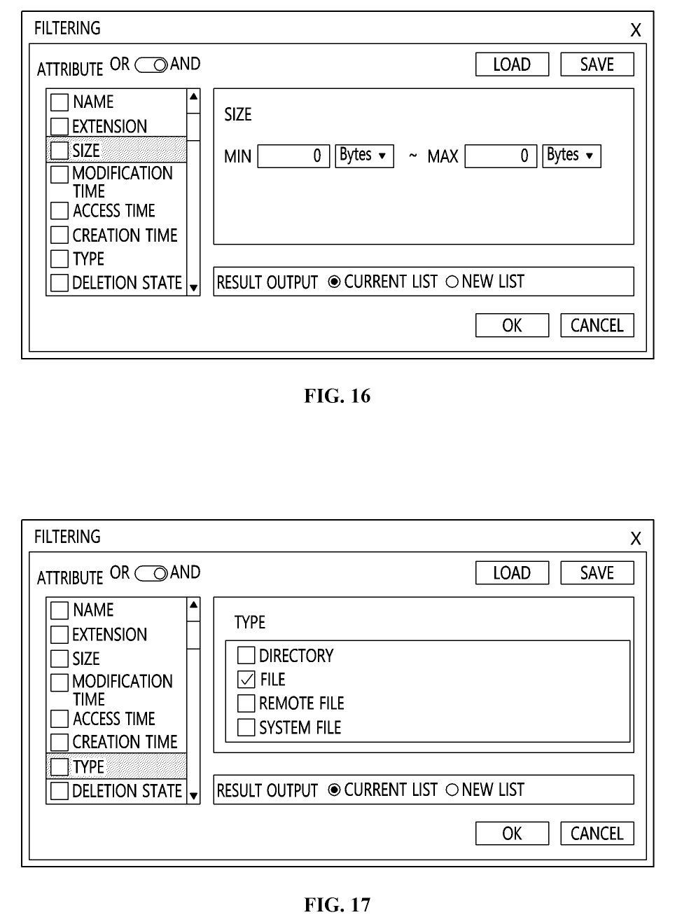

In the example of FIG. 15, a condition is created to search for files whose modification time falls within the range [2022-08-29 12:00:00, 2023-08-29 12:00:00]; in the form (attribute i, an operator p in the condition, and a value j), this may be expressed as ‘(modification time, within range, [2022-08-29 12:00:00, 2023-08-29 12:00:00])’. In addition, various operator and value input sections may be provided, such as a section for size-range conditions (see FIG. 16) and a section for selecting a specific value for the type attribute (see FIG. 17).

### Example of filter creation (condition type 2)

When creating a filter of condition type 2, the dialog box can be broadly divided into: ① an operator settings section; ② a target attribute selection section; ③ a condition operator input section; ④ a result output list settings section; and ⑤ a save/load management section. In the operator settings section, the logical operator to be used when creating the filter is set. In the target attribute selection section, the attributes corresponding to attribute i and attribute j in the condition (attribute i, an operator q in the condition, and an attribute j) are selected, and in the condition operator input section, the operator q in (attribute i, an operator q in the condition, and an attribute j) is selected. When one or more conditions are added, the condition type 2 conditions are combined according to the set logical operator, and the combined condition may be displayed in its entirety.

### Example of filter creation (condition type 3)

When creating a filter of condition type 3, the dialog box can be broadly divided into: ① an operator settings section; ② a target set selection section; ③ a condition operator input section; ④ a result output list settings section; and ⑤ a save/load management section. In the operator settings section, the logical operator to be used when creating the filter is set. In the target set selection section, the sets corresponding to set i and set j in the condition (set i, an operator r in the condition, and set j) are selected, and in the condition operator input section, the operator r in (set i, an operator r in the condition, and set j) is selected. When one or more conditions are added, the condition type 3 conditions are combined according to the set logical operator, and the combined condition may be displayed in its entirety. The target set may be selected as the entire digital evidence set shown in FIG. 3, a digital evidence set created during the filtering process, or a digital evidence set created by user selection without the filtering process; alternatively, it may be any arbitrary set defined by the user.

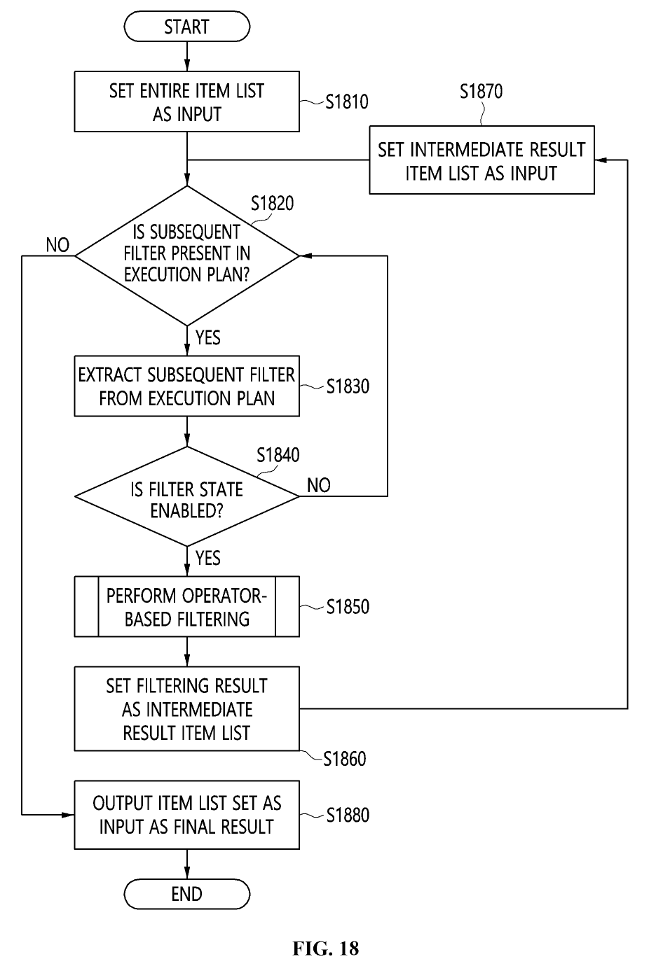

FIG. 18 is a flowchart for explaining a filtering step according to an embodiment.

Referring to FIG. 18, at the filtering step (S250), an item list comprising all digital evidence is first set as the filter input at step S1810.

This initialization may be performed at the start of filtering (e.g., at step S1810). The filter may correspond to filter 1 in FIG. 3.

Subsequently, at step S1820, it is determined whether additional filters are present in the filter execution plan. If so, at step S1830, the filters are sequentially extracted from the execution plan.

Here, when the filtering is first performed, the subsequent filter to be processed is the first filter listed in the filter execution plan.

Subsequently at step S1840, it is determined whether the filter is enabled. If the filter is not enabled, processing returns to step S1820 to extract the next filter from the execution plan.

If the filter is enabled, operator-based filtering is performed at step S1850 using the current item list as input, and, at step S1860, the filtering result is set as the intermediate result item list.

Subsequently, the intermediate result item list is set as the input again at step S1870, after which the process proceeds to step S1820.

When it is determined at step S1820 that additional filters are present in the filter execution plan, the operator-based filtering process is repeated from the filter extraction at step S1830.

Then, operator-based filtering is performed using the intermediate result item list as the input to the extracted subsequent filter; this corresponds to filters 2 through n illustrated in FIG. 3.

Conversely, if it is determined at step S1820 that there is no subsequent filter in the filter execution plan, the current input item list is output as the final result at step S1880.

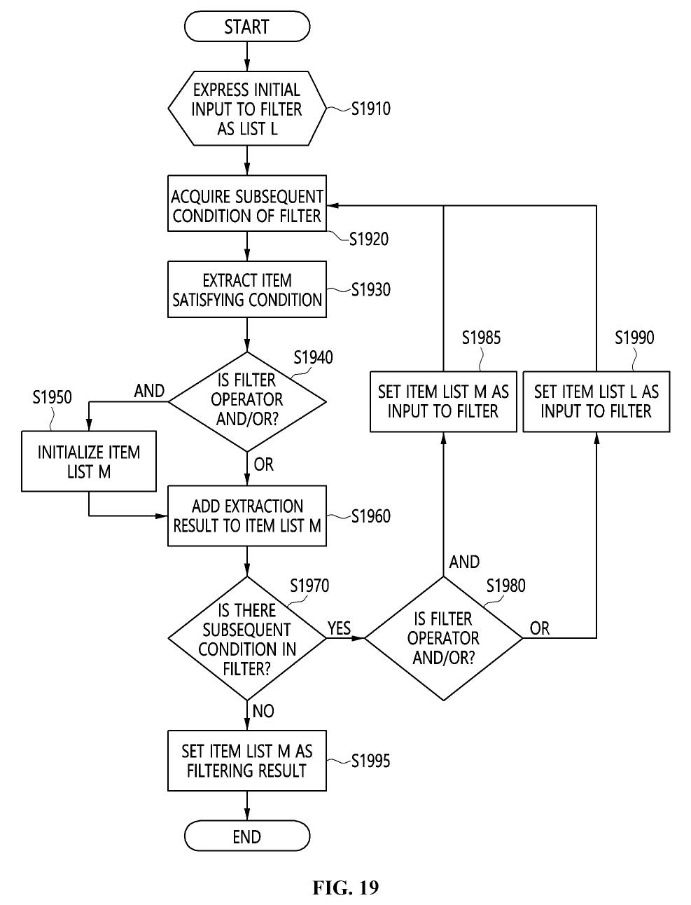

FIG. 19 is a flowchart for explaining operator-based filtering according to an embodiment.

FIG. 19 shows the detailed steps of the operator-based filtering (S1850) in the above-described filtering step (S250). For descriptive convenience, the item list comprising digital evidence items that is set as the filter input is denoted L at step S1910, and the output item list is denoted M.

Referring to FIG. 19, at the operator-based filtering step (S1850), first, a condition is acquired from the filter at step S1920. Subsequently, only items that satisfy the acquired condition are extracted from item list L at step S1930.

Before adding the extracted items to item list M, the type of the operator set in the filter is checked at step S1940.

When it is determined at step S1940 that the operator is AND, item list M is initialized at step S1950, after which the extraction result is added to item list M at step S1960. When the operator is OR, the extraction result is added to item list M at step S1960 without initialization of item list M.

After the extraction result is added to item list M, it is determined at step S1970 whether another condition is present in the filter.

When it is determined at step S1970 that there is no subsequent condition, item list M is set as the filtering result at step S1995, thereby terminating the process.

Conversely, when it is determined at step S1970 that another condition is present, the process to be performed varies depending on the operator set in the filter.

That is, when the operator AND is set at step S1980, item list M is set as the input to the filter at step S1985, but when OR is set, item list L, which was set as the initial input, is set as the input to the filter at step S1990, after which the process is repeated by proceeding to step S1920.

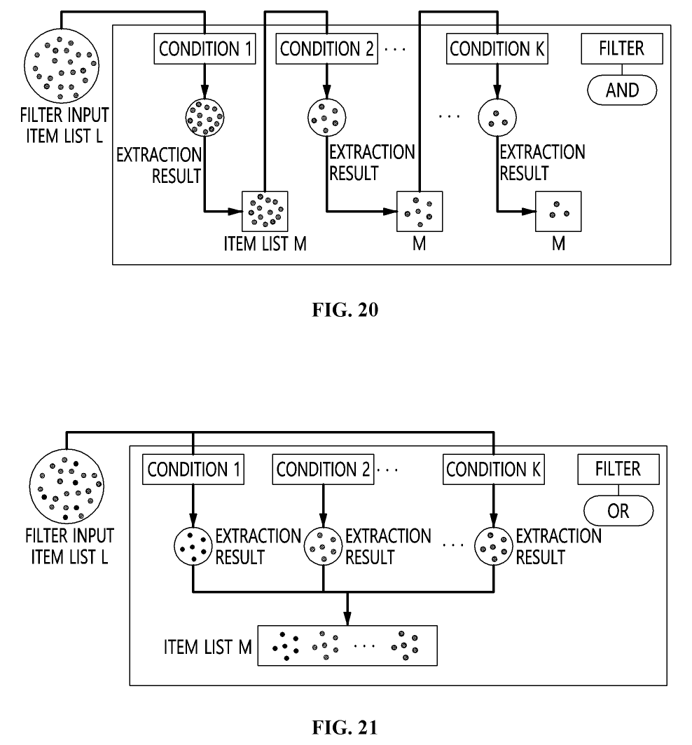

FIG. 20 is an exemplary view of operator-based filtering when AND is set as the filter operator.

Referring to FIG. 20, because items satisfying each condition are extracted and then used as input to the filter again, digital evidence that satisfies all conditions is acquired as a filtering result.

FIG. 21 is an exemplary view of operator-based filtering when OR is set as the filter operator.

Referring to FIG. 21, after items satisfying each condition are extracted, the results are continually added to item list M, and, because the initial item list L continues to be used as the input to the filter, digital evidence that satisfies any one of the multiple conditions is acquired as the filtering result.

When the item list is output as the final result at the last step of FIG. 18, if ‘Current List’ is selected in the result output list settings section of the filter creation dialog box illustrated in FIG. 13, item list M in FIG. 19 is displayed as the default output item list.

However, in order to further improve the effectiveness of selecting relevant digital evidence, a method for outputting the filtering result to a new item list, M', is provided in an embodiment.

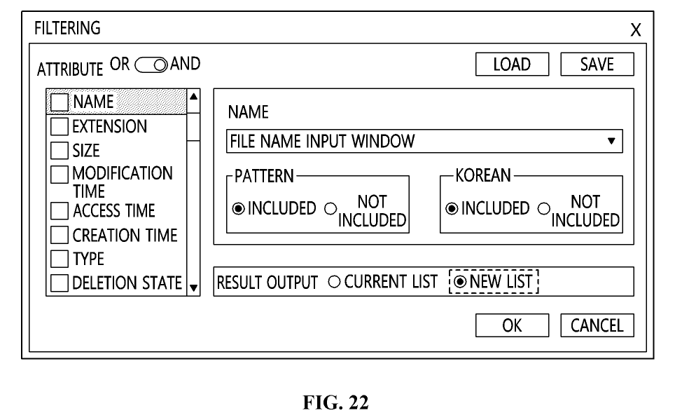

FIG. 22 is an exemplary view of a filter dialog box in which the result is set to be output to a new list.

Referring to FIG. 22, when ‘New List’ (among ‘Current List’ and ‘New List’ at the bottom of the filter creation dialog box) is selected, the filtering result that satisfies the current condition is output to a new item list, M'.

A user may select whether to continue filtering by outputting the filtering result to the current list or continue filtering by outputting the filtering result to a new list, and alternatively, filtering may be performed while maintaining both cases.

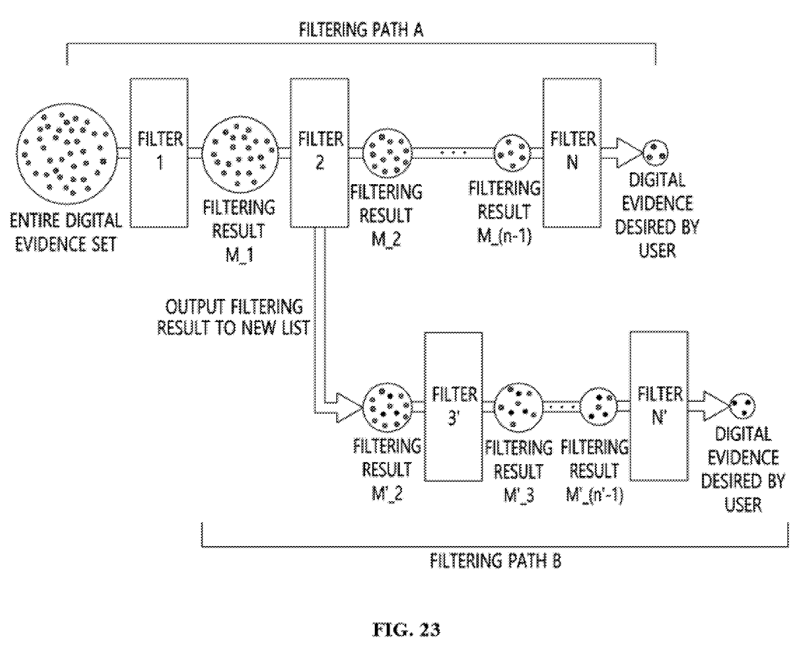

FIG. 23 is an exemplary view of filtering when the filtering result is output to a new list.

FIG. 23 shows a case in which, when the filtering process of FIG. 3 is assumed to be the process of outputting the filtering result to item list M, filtering is performed by outputting the filtering result to a new list M' during the corresponding filtering process.

As illustrated in FIG. 23, when a new filtering path B is added to the existing filtering path A, multiple evidence sets may be processed in parallel, and the filtering paths may be managed both sequentially and in parallel, thereby enabling more effective filtering.

FIG. 23 shows an example of a single new list for descriptive convenience. However, in an embodiment, there is no limit on the number of new lists, and the number may gradually increase according to the need of a user.

In addition to creating a new list by outputting a filtering result, the present disclosure also provides a method of creating a new list from arbitrary items selected by a user. Methods are further provided for copying items between lists, moving items between lists, and removing items from a list. Through these methods, a user may more effectively select and acquire only the relevant digital evidence desired by the user.

After completion of the filtering step in FIG. 2, the filtering result is obtained and then the filtering result visualization step is started.

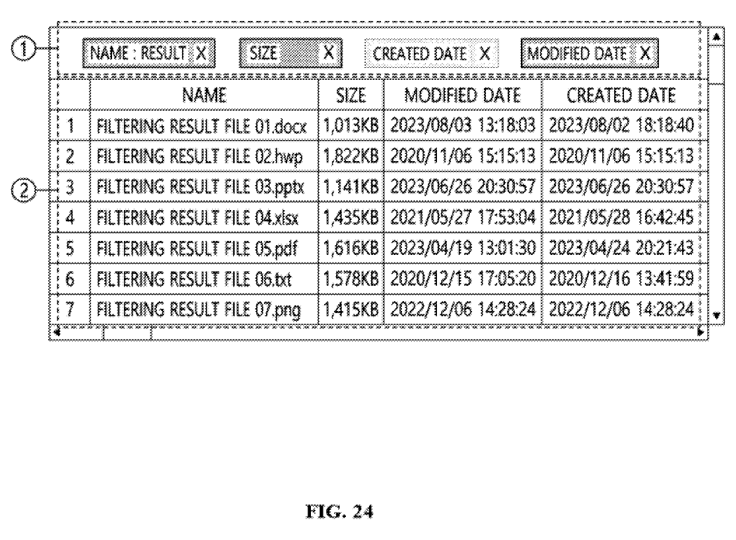

FIG. 24 is an exemplary view of a visualized filtering result according to an embodiment.

Referring to FIG. 24, the visualized filtering result may be largely divided into two areas. Here, area ① is a filter visualization area, and area ② is a result item visualization area.

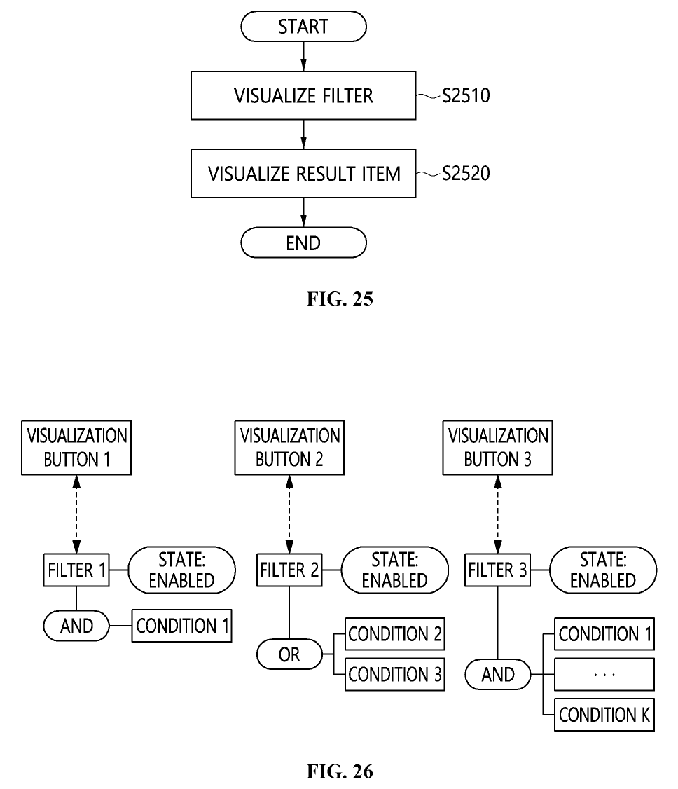

FIG. 25 is a flowchart for explaining a filtering result visualization step according to an embodiment.

Referring to FIG. 25, the filtering result visualization step (S260) according to an embodiment may include a filter visualization step (S2510) and a result item visualization step (S2520).

In FIG. 24, area ① may be displayed through the filter visualization step (S2510), and area ② may be displayed through the result item visualization step (S2520).

At the filter visualization step (S2510), each filter created in the filter creation step (S220) of FIG. 2 is displayed in the form of a button.

FIG. 26 is an exemplary view of visualization of a filter according to an embodiment.

Referring to FIG. 26, assuming that filters 1 and 3 use AND and filter 2 uses OR, filters 1-3 are visualized in the form of visualization button 1, visualization button 2, and visualization button 3, respectively, and are displayed in area ① of FIG. 24.

In the example in FIG. 26, both the visualization button of the filter using AND and the visualization button of the filter using OR are represented in the same color and shape however, they may alternatively be distinguished by different colors or shapes, according to the application.

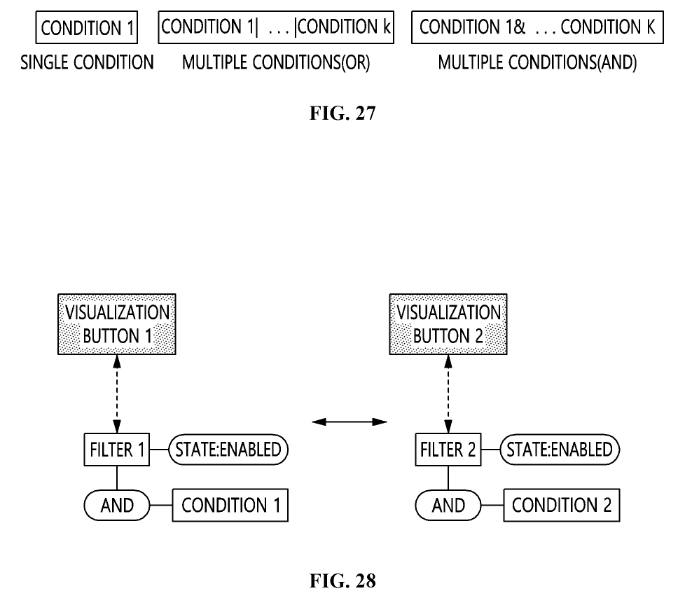

FIG. 27 is an exemplary view of a visualization button for displaying the content of a condition according to an embodiment.

Referring to FIG. 27, the form of information displayed on a visualization button represents the content of the condition; when multiple conditions are present, the operators OR and AND may be represented by ‘|’ and ‘&’, respectively.

The displayed content may vary depending on the type of the condition. In the case of condition type 1, the necessary elements in the form (attribute i, an operator p in the condition, and a value j) may be shown. In the case of condition type 2, the necessary elements in the form (attribute i, an operator q in the condition, and an attribute j) may be shown. In the case of condition type 3, the necessary elements in the form (set i, an operator r in the condition, and set j) may be shown.

FIG. 28 is an exemplary view of a visualization button according to the enabled state of a filter.

Referring to FIG. 28, when a filter is enabled, the corresponding visualization button is displayed in a darker color, and when the filter is disabled, it is displayed in a lighter color.

The enabled and disabled states may be distinguished by color intensity as in the embodiment, or by other visual differentiators such as different colors, shapes, borders, or icons.

The state of a visualization button may be changed in response to a user action-such as a double-click, a single click, or selection from a context menu-and switching between enabled and disabled states may be performed through other types of user actions depending on the application.

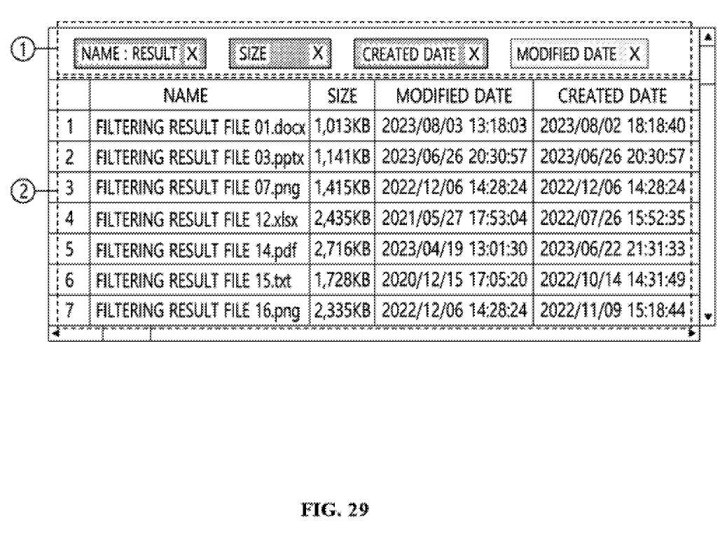

FIG. 29 is an exemplary view of switching between enabled and disabled states in filter visualization.

FIG. 29 shows that the filter applied to the ‘modified date’ attribute in FIG. 24 is switched from the enabled state to the disabled state, and that the filter applied to the ‘created date’ attribute in FIG. 24 is switched from the disabled state to the enabled state.

As shown in FIG. 29, the filter applied to the ‘modified date’ attribute is switched to the disabled state and therefore does not participate in the filtering process illustrated in FIG. 18.

At the result item visualization step, the filtering result obtained at the filtering step is displayed in area ② in tabular form, as illustrated in FIG. 29. In FIG. 29, an example of digital evidence in the form of a file having multiple attributes is illustrated as the filtering result; in addition to the attributes given as examples, other attributes suitable for the application may also be provided.

In the proposed disclosure, at the result visualization step, filtering result items are displayed in the result item visualization area, and the filters that produced the results are displayed in the filter visualization area.

As shown in FIG. 29, a user can intuitively confirm that the filtering result items are obtained through the filters applied to the ‘name’, ‘size’, and ‘created date’ attributes.

The visualized filters enable a user to immediately understand how the current filtering result was obtained without additional interpretation and reduce the effort required to recall the conditions used to create the filters, thereby improving the efficiency of investigation, inspection, and audit of digital evidence.

Even when the filtering result is output to a new list, the filtering result may be visualized in the same manner as described above.

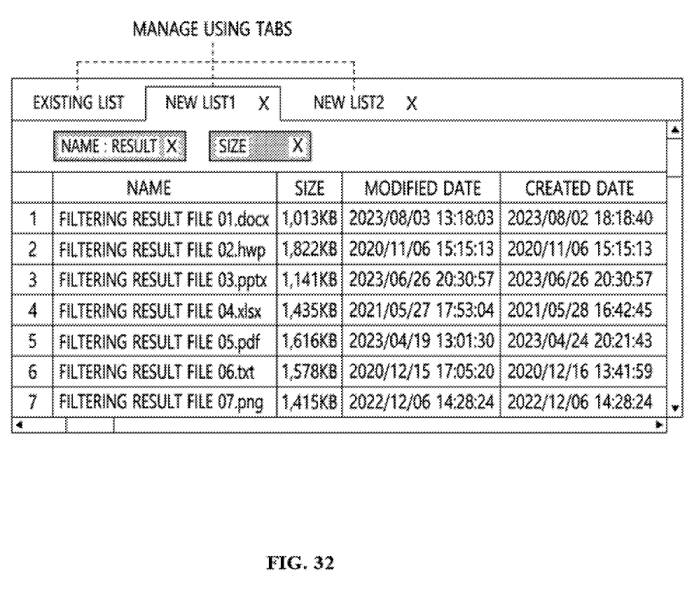

FIG. 32 is an exemplary view of visualization of filtering results when the filtering result is output to a new list.

Referring to FIG. 32, a filter visualization area and a result item visualization area are created for each new list. When the newly created lists are named ‘NEW LIST 1’ and ‘NEW LIST 2’, tabs are used to manage them separately.

When the filtering result is output to a new list, the condition(s) that produced the result are displayed in the filter visualization area upon creation of the new list, allowing the user to immediately understand that the new list was created under the displayed condition(s).

A tab for managing a new list may be created from a filtering result or from an arbitrary set of items selected by the user. The tab name (e.g., ‘New List 1’ in FIG. 32) may be edited by the user, and the tab may be removed.

Because lists are managed by separate tabs, a user may perform filtering and filtering result visualization in any desired tab, and digital evidence can be managed in parallel across one or more tabs as needed for effective selection.

The filters created through the steps shown in FIG. 2 may be updated in response to a user request; in the filter update process, filter conditions may be modified, filter states may be changed, or a filter may be removed.

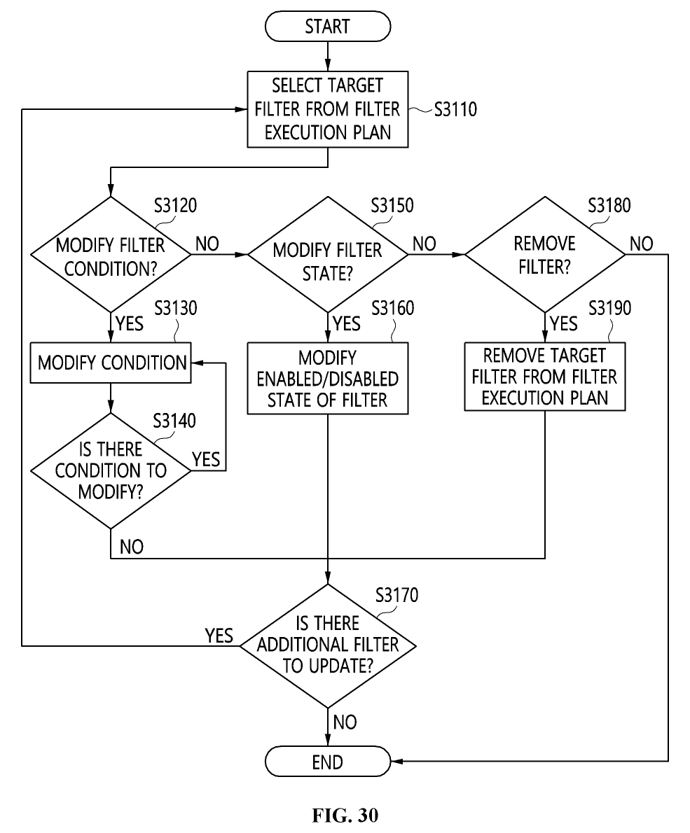

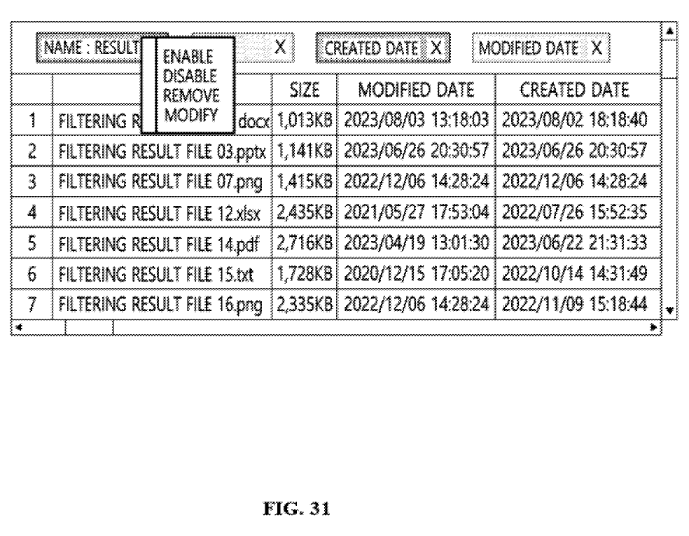

FIG. 30 is a flowchart for explaining filter update step according to an embodiment, and FIG. 31 is an exemplary view of a context menu of a filter visualization button.

Referring to FIG. 30, upon each request, one of the following processes may be performed: modifying a filter condition, changing a filter state, or removing a filter. When the update is completed, the filtering step (S250) and the filtering result visualization step (S260) are performed, as shown in FIG. 2, thereby updating the filter visualization buttons and the filtering result items.

Modifying a filter condition at steps S3120-S3140 may be performed by selecting the visualization button of the target filter the condition of which is to be modified and invoking a filter-condition modification function through a user action, such as selecting a context-menu item, as shown in FIG. 31.

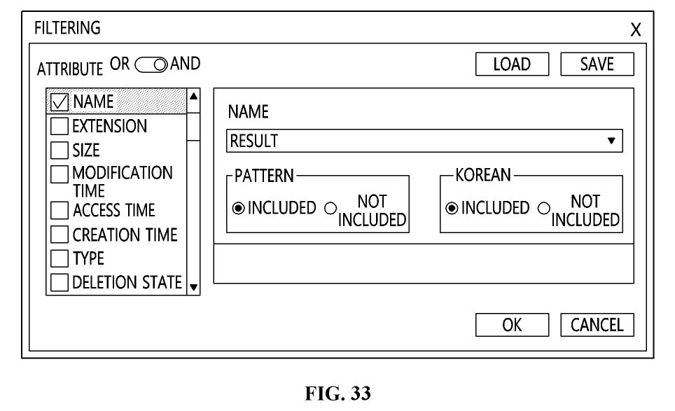

FIG. 33 is an exemplary view of modification of a filter condition according to an embodiment.

Referring to FIG. 33, when the filter-condition modification function is invoked, a window identical to the window used to enter a condition when the filter was created is displayed, and the previously entered condition may also be shown. A user may enter a new condition, and, when the modification is completed, the filtering step (S250) and the filtering result visualization step (S260) are performed to update the filter visualization buttons and the filtering result items.

Changing the state of a filter at steps S3150 to S3160 may be performed by selecting the visualization button of the target filter, the state of which is to be changed, as shown in FIG. 31, and by changing the state of the filter via the context menu or by double-clicking the visualization button. When ‘Enable’ is selected from the context menu, the visualization button of the filter is switched to an enabled state, but when ‘Disable’ is selected from the context menu, the visualization button of the filter is switched to a disabled state.

When the state is changed through double-click, if the state is an enabled state, it is switched to the disabled state, but if it is a disabled state, it is switched to the enabled state. Through the context menu or a double-click, a user may readily change the state of the filter, and when the state of the filter is changed, the filtering step and the filtering result visualization step are performed to update the filter visualization buttons and the filtering result items. Other user actions may also be used to switch the state of the filter, depending on the application.

Removing a filter at steps S3180 to S3190 may be performed by selecting the visualization button of the target filter as shown in FIG. 31, and selecting the removal function from the context menu or clicking the X-shaped removal button displayed on the visualization button. The filter may also be removed through other types of user action, depending on the application.

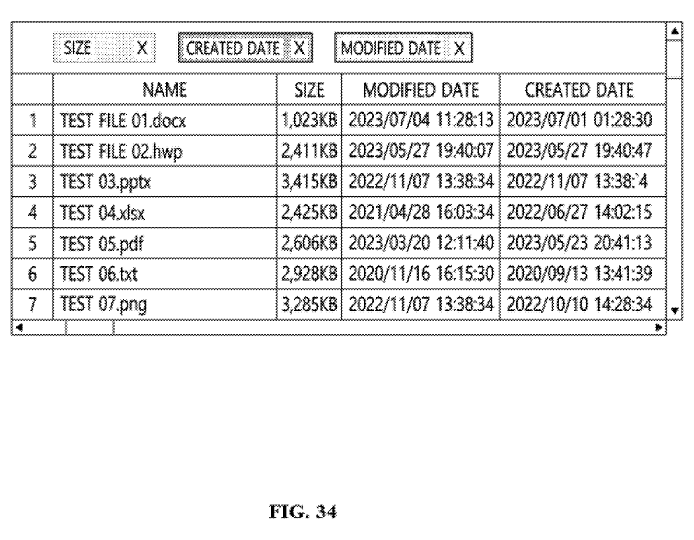

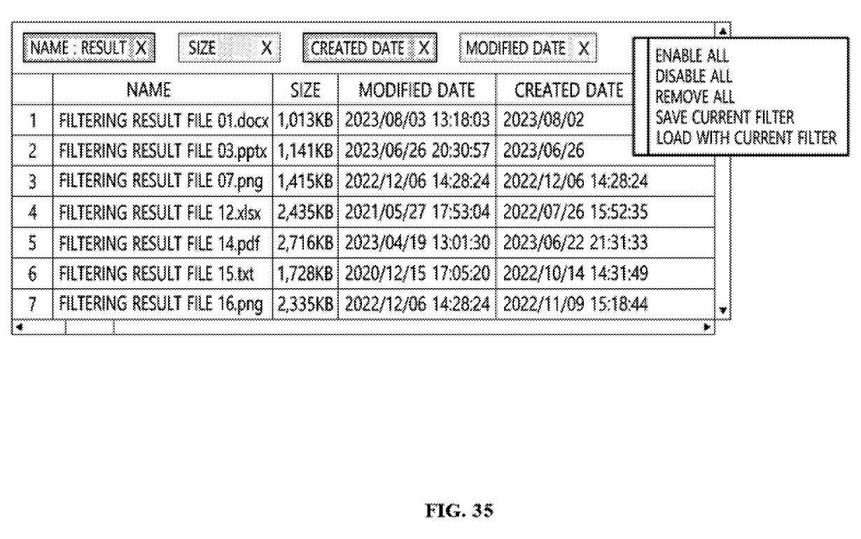

FIG. 34 is an exemplary view displayed when a filter visualization button is removed according to an embodiment, and FIG. 35 is an exemplary view of an integrated context menu of a filter visualization button.

Referring to FIG. 34, when the created filter is removed through the filter removal function, the visualization button of the corresponding filter is removed, and the filtering step (S250) and the filtering result visualization step (S260) are performed again to update the visualization button and the filtering result items.

In addition, when the context menu is invoked without selecting any visualization button, as shown in FIG. 35, enable/disable/remove operations may be applied simultaneously to all visualization buttons via ‘Enable All’, ‘Disable All’, and ‘Remove All’.

When all visualization buttons in FIG. 35 are removed so that no visualization button remains, this indicates that no filter exists in the filter execution plan. Accordingly, the entire item list is used as the output according to the execution flow of FIG. 18, and the result items are updated. Similarly, even if visualization buttons remain, when all visualization buttons are disabled, the entire item list is used as the output according to the execution flow of FIG. 18, and the result items are updated.

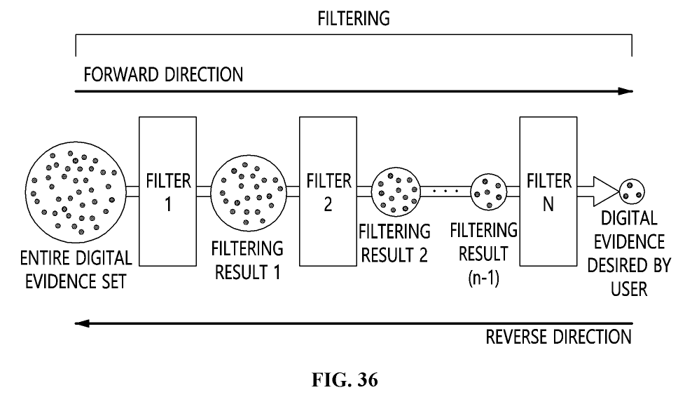

FIG. 36 is a concept diagram for explaining a filtering process using a visualization button.

Referring to FIG. 36, because the state of a visualization button can be readily switched between enabled and disabled, both forward filtering and reversion to a pre-filtered state can be performed simply, and, through the filter update step (S240), conditions can be modified until the desired filtering result is obtained. Forward and reverse navigation in the filtering process may be performed whether the filtering result is output to the current list or to a new list.

At the filter creation step (S220), the currently set operator(s), the selected attributes, and the entered conditions may be stored in a file via the SAVE button in the save/load management section of FIG. 13, and the operator(s), selected attributes, and entered conditions may be reloaded from the saved file via the LOAD button.

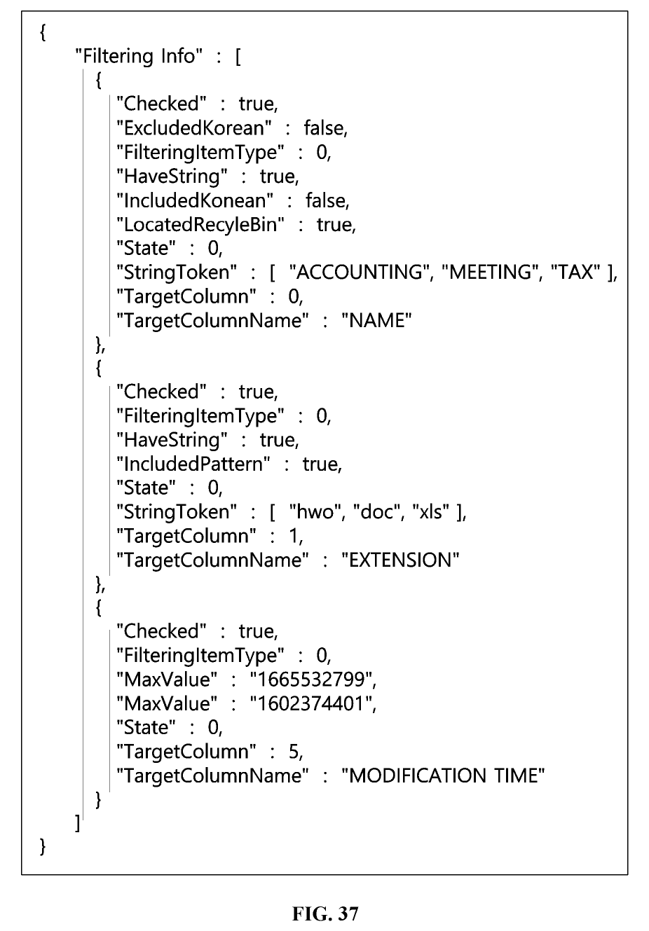

FIG. 37 is an exemplary view of a JSON file used to store filter information.

Referring to FIG. 37, an example of a file structure for storing filter information and loading stored filters is illustrated. In the present embodiment, the JSON format is used; however, other file formats may be used as needed.

In addition, instead of using the filter creation dialog box of FIG. 13, the currently configured filter information for the visualization buttons may be stored or loaded via the context-menu functions ‘Save Current Filter’ and ‘Load with Current Filter’ shown in FIG. 35.

According to the disclosed embodiment, a user may effectively select and retain only the digital evidence relevant to a case.

That is, by applying multiple filters sequentially and in parallel, the size of the candidate set may be effectively reduced, and only digital evidence related to the case may be finally obtained.

Moreover, various attributes of digital evidence may be used as filter conditions, and operators and relationships between conditions may be set. Accordingly, conditions may be freely combined according to the objective of selecting relevant digital evidence, enabling effective selection of relevant digital evidence.

In addition, a filter visualization button, provided together with the filtering result after filtering is performed, enables users to intuitively understand the conditions under which the currently selected items were obtained as the filtering result, thereby enabling the effective selection of relevant digital evidence.

Further, efficient selection of relevant digital evidence may be achieved by reducing the effort required to interpret the resulting items and allowing users to focus on selection itself.

Once created, the filter visualization button facilitates switching between enabled and disabled states through a simple interface. Because only the conditions of enabled visualization buttons participate in the filtering step, previously created filters may be readily reused, which greatly improves the efficiency of selecting relevant digital evidence. Conditions may also be modified or removed through the simple interface, further improving efficiency. This simplifies both forward and reverse filtering, enabling the desired filtering result to be effectively obtained.

The capability to output a filtering result to a new list allows multiple filtering paths to be handled in parallel and supports copying or moving items between different lists and removing items from a list, thereby enabling the effective selection of relevant digital evidence.

The ability to save and load filters to and from files enhances the reuse of filter information. On the same computer, filter information may be reused by loading a saved file; across multiple computers, the information may also be reused by copying a file containing the filter information to another computer. When multiple people participate in selecting relevant digital evidence, users may share filter information, and the information may be organized by category and reused on an ongoing basis.

As a result, according to the disclosed embodiment, effective and efficient selection of relevant digital evidence may be achieved when conducting investigation, inspection, and audit in a judicial system in which only digital evidence related to the criminal fact must be selected and extracted from digital storage media.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. An apparatus for operator-based filtering for selecting relevant digital evidence, comprising:
memory in which at least one program is recorded; and
a processor for executing the program,
wherein the program performs:
creating at least one filter in response to a request from a user and adding the created at least one filter to a filter execution plan,
filtering digital evidence provided as input using the at least one filter added to the filter execution plan, and
visualizing the result of the filtering.

2. The apparatus of claim 1, the filter may be configured with an operator, a state, and at least one condition.

3. The apparatus of claim 2, wherein the operator includes at least one of a logical operator, a set operator, a relational operator, or a user-defined operator, or a combination thereof.

4. The apparatus of claim 2, wherein the condition includes at least one of:
a first condition type configured with (attribute i, an operator p in the condition, and a value j) to check whether a relationship between a value acquired from attribute i of the digital evidence and the value j satisfies the operator p;
a second condition type configured with (attribute i, an operator q in the condition, and an attribute j) to check whether a relationship between a value acquired from attribute i of the digital evidence and a value acquired from attribute j satisfies the operator q; or
a third condition type configured with (set i, an operator r in the condition, and set j) to check whether the digital evidence set i and the digital evidence set j satisfy the operator r as operands or a combination thereof.

5. The apparatus of claim 1, wherein, when adding the created at least one filter, the program performs creating a composite filter by combining the created at least one filter with at least one additional filter through an operator.

6. The apparatus of claim 1, the order in which the at least one filter added to the filter execution plan is applied may be changed using an execution plan optimization technique.

7. The apparatus of claim 1, wherein, when filtering digital evidence, the program may perform:
setting an item list comprising all digital evidence as input to the filter,
sequentially extracting a filter in an enabled state from the filter execution plan, and
performing operator-based filtering on the item list using the sequentially extracted filter.

8. The apparatus of claim 7, wherein, when performing the operator-based filtering, the program performs:
acquiring a condition from the filter,
extracting at least one item that satisfy the acquired condition from the item list, and
initializing the item list or adding the extracted at least one item based on a type of an operator set in the filter.

9. The apparatus of claim 8, wherein, when the operator is AND, the program initializes the item list and adds the extracted at least one item to the item list, whereas when the operator is OR, the program adds the extracted at least one item to the item list without initialization of the item list.

10. The apparatus of claim 1, wherein:
the result of the filtering may include an area for filter visualization and an area for result item visualization, and
the filter may be visualized through a visualization button.

11. The apparatus of claim 1, wherein:
the program further performs filter update for modifying conditions of the filter, and
when performing the filter update, the program performs:
receiving a selection of a visualization button corresponding to a target filter, a condition of which is to be modified, from the user and performing at least one of modification of the condition of the selected filter, modification of a state of the selected filter, or removal of the selected filter, or a combination thereof depending on input by the user.

12. A method for operator-based filtering for selecting relevant digital evidence, comprising:
creating at least one filter in response to a request from a user and adding the created at least one filter to a filter execution plan;
filtering digital evidence provided as input using the at least one filter added to the filter execution plan; and
visualizing a result of the filtering.

13. The method of claim 12, the filter may be configured with an operator, a state, and at least one condition.

14. The method of claim 13, wherein the operator includes at least one of a logical operator, a set operator, a relational operator, or a user-defined operator, or a combination thereof.

15. The method of claim 13, wherein the condition includes at least one of:
a first condition type configured with (attribute i, an operator p in the condition, and a value j) to check whether a relationship between a value acquired from attribute i of the digital evidence and the value j satisfies the operator p;
a second condition type configured with (attribute i, an operator q in the condition, and an attribute j) to check whether a relationship between a value acquired from attribute i of the digital evidence and a value acquired from attribute j satisfies the operator q; or
a third condition type configured with (set i, an operator r in the condition, and set j) to check whether the digital evidence set i and the digital evidence set j satisfy the operator r as operands or a combination thereof.

16. The method of claim 12, wherein adding the created at least one filter comprises:
creating a composite filter by combining the created at least one filter with at least one additional filter through an operator.

17. The method of claim 12, wherein filtering digital evidence comprises:
setting an item list comprising all digital evidence as input to the filter,
sequentially extracting a filter in an enabled state from the filter execution plan, and
performing operator-based filtering on the item list using the sequentially extracted filter.

18. The method of claim 17, wherein performing the operator-based filtering comprises:
acquiring a condition from the filter,
extracting at least one item that satisfy the acquired condition from the item list, and
initializing the item list or adding the extracted at least one item based on a type of an operator set in the filter.

19. The method of claim 12, wherein:
the result of the filtering may include an area for filter visualization and an area for result item visualization, and
the filter may be visualized through a visualization button.

20. The method of claim 12, further comprising:
performing filter update for modifying conditions of the filter,
wherein performing the filter update comprises:
receiving a selection of a visualization button corresponding to a target filter, a condition of which is to be modified, from the user, and
performing at least one of modification of the condition of the selected filter, modification of a state of the selected filter, or removal of the selected filter, or a combination thereof depending on input by the user.
